(19) United States
(12) Patent Application Publication
(10) Pub. No.: US 2006/0213748 A1
(43) Pub. Date: Sep. 28, 2006

(54) Hydraulic clutch actuation system

(75) Inventor: Volker Lang, Lauf (DE)

Correspondence Address: DAVIDSON, DAVIDSON & KAPPEL, LLC, 485 SEVENTH AVENUE, 14TH FLOOR, NEW YORK, NY, 10018, US

(73) Assignee: LUK LAMELLEN UND KUPPLUNGSBAU BETEILIGUNGS KG, Buehl (DE)

(21) Appl. No.: 11/386,252

(22) Filed: Mar. 22, 2006

(30) Foreign Application Priority Data
Mar. 26, 2005 (DE) 10 2005 014 001.7
Apr. 8, 2005 (DE) 10 2005 016 134.0

(51) Int. Cl. F16D 25/06

(52) U.S. Cl. 192/85 R

(57) ABSTRACT

A hydraulic clutch actuation system having a cylinder housing part made of plastic, in particular a slave cylinder housing part or a master cylinder housing part, to which another cylinder housing part made of plastic is attached, which has a sliding contact surface for an outer peripheral surface of a piston. To prolong the service life of the hydraulic clutch actuation system, the sliding contact surface or the outer peripheral surface is made of a different plastic material than the base material(s) of the cylinder housing parts of the piston, that has better sliding or wear properties than the plastic material from which the remainder of the additional cylinder housing part, respectively, of the piston is formed.

This application claims the benefit of German Patent Application No. 10 2005 014 001.7 filed Mar. 26, 2005, hereby incorporated by reference herein and German Patent Application No. 10 2005 016 134.0 filed Apr. 8, 2005, hereby incorporated by reference herein.

### BACKGROUND OF THE INVENTION

The present invention provides a hydraulic clutch actuation system having a cylinder housing part made of plastic, in particular a slave cylinder housing part or a master cylinder housing part, to which another cylinder housing part made of plastic is attached, which has a sliding contact surface for an outer peripheral surface of a piston.

### SUMMARY OF THE INVENTION

An object of the present invention may be to devise a hydraulic clutch actuation system having a cylinder housing part made of plastic, in particular a slave cylinder housing part or a master cylinder housing part, to which another cylinder housing part made of plastic is attached, which has a sliding contact surface for an outer peripheral surface of a piston, in such a way that the hydraulic clutch actuation system will be characterized by a longer service life than conventional hydraulic clutch actuation systems.

The present invention provides a hydraulic clutch actuation system having a cylinder housing part made of plastic, in particular a slave cylinder housing part or a master cylinder housing part, to which another cylinder housing part made of plastic is attached, which has a sliding contact surface for an outer peripheral surface of a piston, in that the sliding contact surface or the outer peripheral surface is made of a different plastic material than the base material(s) of the cylinder housing parts of the piston, that has better sliding properties or wear properties than the plastic material used to form the remainder of the additional cylinder housing part, and respectively, of the piston.

The additional cylinder housing part is preferably a weld ring member. The additional cylinder housing part, in particular the weld ring member, is preferably welded onto the first mentioned cylinder housing part. The additional cylinder housing part may, however, also be clipped or pressed in place into the first mentioned cylinder housing part.

Within the context of the present invention, leakage was detected in conventional hydraulic clutch actuation systems, also termed clutch release systems, following a relatively brief operating time. It was found that the leakage is attributable, inter alia, to unwanted abrasive wear potentially occurring at the site of frictional contact between the sliding contact surface and the outer peripheral surface as the result of an eccentric introduction of force by a piston rod into the piston. It was also found that when weld ring members made of filled plastics are used, this abrasive wear causes filling material to be exposed and partially flake off. The exposed and loosened filling material can lead, in turn, to damage to the seals used for sealing the cylinder. The damage to the seals may be minimized by modifying the pairing of materials.

Apart from the sliding contact surface or the outer peripheral surface, the present invention may provide for the additional cylinder housing part, i.e., the weld ring member, and, respectively, the piston, to be made of a preferably filled or reinforced plastic, which is high in strength and, moreover, readily weldable. It is merely the sliding contact surface or the outer peripheral surface that is made of a special plastic material which exhibits superior gliding properties. Another aspect of the present invention provides for the other surface to be made of a conventional thermosetting plastic.

In one preferred exemplary embodiment of the clutch actuation system, the additional cylinder housing part may be formed from two different plastic material components. This makes it possible to reduce the wear at the site of frictional contact between the sliding contact surface and the outer peripheral surface in a cost-effective manner, without adversely affecting the strength or other properties of the additional cylinder housing part.

Another preferred exemplary embodiment of the clutch actuation system preferably provides for the sliding contact surface to be constituted of an unfilled or unreinforced plastic material, and for the remainder of the additional cylinder housing part of a filled or reinforced plastic material. This reliably prevents filling materials or reinforcing materials from being exposed at the sliding contact surface, without degrading the strength or other material properties of the rest of the additional cylinder housing part.

In another preferred exemplary embodiment of the clutch actuation system, the additional cylinder housing part and the cylinder housing part may be made of the same plastic, in particular of polyamide 66. Except for the sliding contact surface, the additional cylinder housing part is preferably filled with glass fibers. The glass-fiber content is preferably about 35%.

In another preferred exemplary embodiment of the clutch actuation system, the sliding contact surface may be made of the same plastic as the rest of the additional cylinder housing part and as the cylinder housing part. This simplifies the manufacturing and disposal of the parts. Moreover, the process of welding the additional cylinder housing part to the cylinder housing part is simplified. However, in contrast to the additional cylinder housing part and the cylinder housing part, the sliding contact surface preferably contains no filling materials or reinforcing materials.

Yet another preferred exemplary embodiment of the clutch actuation system preferably provides for the piston to be made of two different plastic material components. This may reduce the wear at the site of frictional contact between the sliding contact surface and the outer peripheral surface in a cost-effective manner, without adversely affecting the strength or other material properties of the piston.

Another preferred exemplary embodiment of the clutch actuation system preferably provides for the outer peripheral surface of the piston to be constituted of an unfilled or unreinforced plastic material, and for the remainder of the piston of a filled or reinforced plastic material. This reliably prevents filling materials or reinforcing materials from being exposed at the outer peripheral surface, without degrading the material properties of the rest of the piston.

Another preferred exemplary embodiment of the clutch actuation system preferably provides for the outer peripheral surface of the piston to be made of the same plastic as the rest of the piston. This simplifies the manufacturing of the parts. However, in contrast to the piston, the outer peripheral surface does not contain any filling materials or reinforcing materials.

Yet another preferred exemplary embodiment of the clutch actuation system preferably provides for the sliding contact surface or the outer peripheral surface to be constituted of a material having modified sliding properties. To improve the sliding properties, the sliding contact surface or the outer peripheral surface may be coated with a special material, in particular a special plastic material, such as polytetrafluoroethylene.

Yet another preferred exemplary embodiment of the clutch actuation system preferably provides for the additional cylinder housing part or the piston to be constituted of a two-component injection-molded part to keep the manufacturing costs low. However, the tooling costs for two-component injection-molded parts may be higher than those for injection-molded parts made of one component.

### BRIEF DESCRIPTION OF THE DRAWINGS

Further advantages and features of the present invention and details pertaining thereto are derived from the following description in which exemplary embodiments are explained in detail with reference to the drawings, in which:

FIG. 1 shows a hydraulic clutch actuation system in a part-sectional view;

FIG. 2 illustrates a weld ring member of the clutch actuation system shown in FIG. 1, in a side view from the right;

FIG. 3 depicts the view of a half section along line III-III in FIG. 2; and

FIG. 4 shows an alternate embodiment where the piston is made of two plastic components.

### DETAILED DESCRIPTION OF A PREFERRED EMBODIMENT

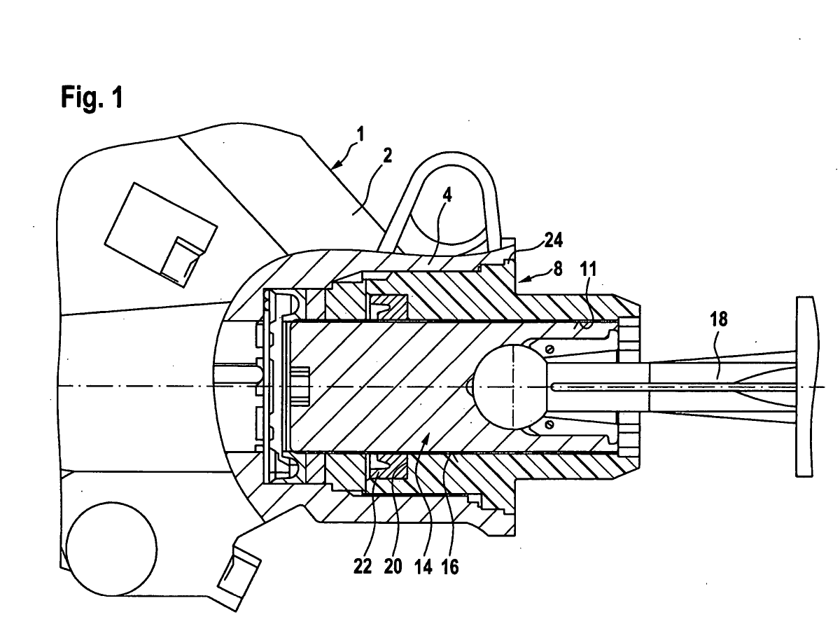

FIG. 1 shows a part-sectional view of a hydraulic clutch-release system 1 according to the present invention, also described as a clutch actuation system. Hydraulic clutch actuation system encompasses a clutch master cylinder 2, which has a clutch master-cylinder housing part 4 shown in a sectional view. A weld ring member 8 is welded onto clutch master-cylinder housing part 4. Weld ring member 8 has an axially symmetrical design and, on the interior, has a sliding contact surface 11 essentially in the form of a circular cylindrical outside surface. Reciprocatingly accommodated in weld ring member 8 is a piston 14 having an outer peripheral surface 16 which, during operation, slides along sliding contact surface 11.

One end of a piston rod 18 is linked or coupled, for example pin connected, to piston 14. The purpose of piston rod 18 is to introduce an actuating force into piston 14. At its end facing away from piston rod 18, weld ring member 8 has a recess 20, which is used for accommodating a radial sealing ring 22. Weld ring member 8 has a radially outwardly extending collar 24. Collar 24 is used, inter alia, for positioning weld ring member 8 relative to clutch master-cylinder housing part 4, before being welded onto the same.

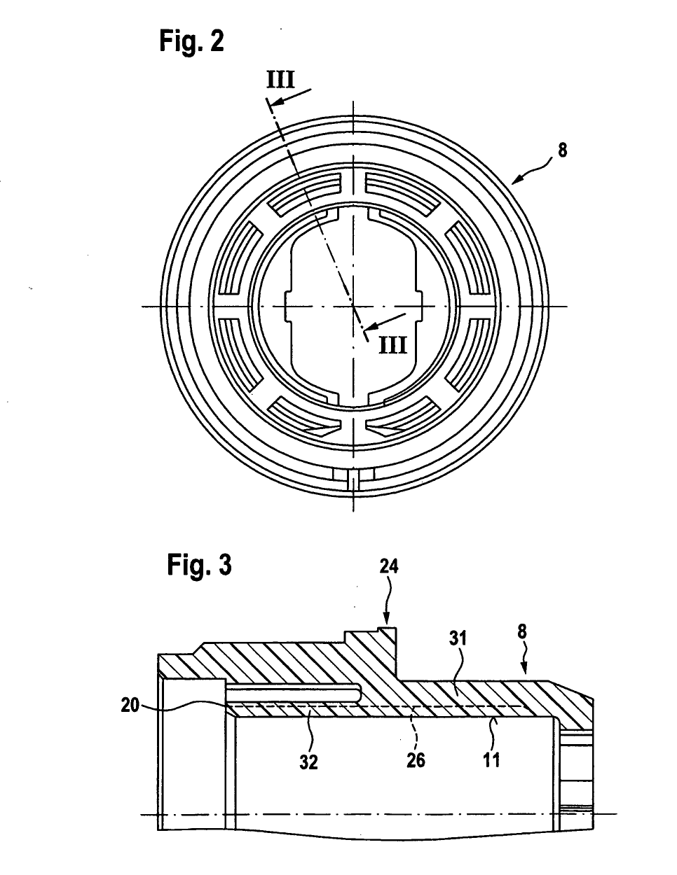

In FIGS. 2 and 3, weld ring member 8 is shown by itself, in different views. FIG. 2 shows a side view of weld ring member 8 from the right. FIG. 3 illustrates the view of a half section along line III-III in FIG. 2.

In FIG. 3, a dashed line 26 indicates a separating line between a first plastic component 31 and a second plastic component 32, which form weld ring member 8. Second plastic component 32 forms a sleeve, essentially in the form of a circular cylindrical outside surface, whose inner peripheral surface area constitutes sliding contact surface 11. The remaining part of weld ring member 8 is formed from the first plastic component, but is integrally joined in one piece to the sleeve which has sliding contact surface 11 and is formed from the second plastic component.

A polyamide 66 having a glass-fiber content of 35% is preferably used for first plastic component 31. For second plastic component 32, a polyamide 66 is likewise used, but, in this case, is unfilled. Piston 14 (in FIG. 1) is preferably made of a thermosetting plastic marketed under the name Vyncolit X680. Clutch master-cylinder housing part 4 (in FIG. 1) is preferably likewise made of polyamide 66 having a glass-fiber content of 35%.

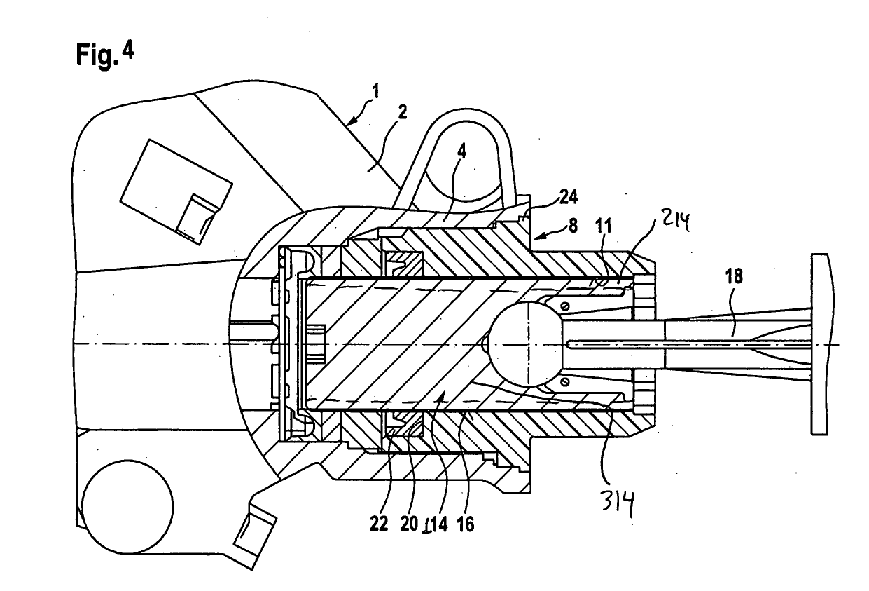

In FIG. 4, an alternate embodiment in which the piston 114 is made of a first plastic component 214, for example unfilled plastic material, and a second base component 314 made for example of filled plastic material.

In conventional clutch actuation systems, an eccentric introduction of force by the piston rod results in manifestations of wear between the piston and the weld ring member. Wear experienced at the site of frictional contact causes filling materials in the form of glass fibers to be exposed on the piston. The exposed glass fibers damage the seal, with the result that the cylinder becomes pervious. By modifying the pairing of materials (weld ring having polytetrafluoroethylene and glass fibers as filling material and the piston having glass bead reinforcement instead of glass fibers), this damage to the seal is able to be appreciably reduced. However, the drawback inherent in such pairing of materials is that the weld ring material is very expensive, and the use of polytetrafluoroethylene leads to significant tool wear, since the polytetrafluoroethylene decomposes in the injection-molding process. Moreover, the weldability is degraded.

To overcome this problem, it was envisaged to fabricate the weld ring material without filling materials. Speaking against this, however, was a high level of moisture absorption and the resultant poor weldability, which, however, may be compensated by drying or dry storing of the parts. One problem that became apparent within the context of the present invention was discovering a material that has little to no filling material, is readily weldable, is more cost effective than conventional materials, is more easily processible, and that absorbs little moisture.

The present invention provides for a material without filling material to be used on at least one sliding contact surface. The remainder of the weld ring or of the piston is made of a reinforced material that absorbs little moisture, is readily welded, and also fulfills the remaining demands on the material. One principal aspect of the present invention provides for a two-component approach. This means that the outer peripheral surface and/or the sliding contact surface for the piston are/is made of an unreinforced material or of a material having modified sliding properties. All of the rest of the weld ring member and/or of the piston may be composed, for example, of a polyamide 66 having a glass-fiber content of 35%

### REFERENCE NUMERAL LIST

1 hydraulic clutch release system
2 hydraulic clutch master cylinder
4 clutch master-cylinder housing part
8 weld ring member
11 sliding contact surface
14 piston
16 outer peripheral surface
18 piston rod
20 recess
22 radial sealing ring
24 collar
26 dashed line
31 first plastic component
32 second plastic component
114 piston
214 first plastic component
314 second plastic component

What is claimed is:

1. A hydraulic clutch actuation system comprising:
a piston having an outer peripheral surface;
a plastic cylinder housing part; and
a plastic weld ring member, the plastic weld ring member having a first plastic component attached to the plastic cylinder housing part and a sliding contact surface for the outer peripheral surface of the piston,
the sliding contact surface or the outer peripheral surface being made of a different plastic material than the plastic cylinder housing part and the first plastic component, the different plastic material having better sliding or wear properties than a plastic material of the first plastic component.

2. The hydraulic clutch actuation system as recited in claim 1 wherein the weld ring member is formed from two different plastic material components.

3. The hydraulic clutch actuation system as recited in claim 2 wherein the sliding contact surface includes an unfilled or unreinforced plastic material, and the first plastic component includes a filled or reinforced plastic material.

4. The hydraulic clutch actuation system as recited in claim 1 wherein the weld ring member and the cylinder housing part are made of the same plastic.

5. The hydraulic clutch actuation system as recited in claim 4 wherein the first plastic component includes the sliding contact surface so that the sliding contact surface is made of a same plastic as the first plastic component and the cylinder housing part.

6. The hydraulic clutch actuation system as recited in claim 1 wherein the piston is made of two different plastic material components.

7. The hydraulic clutch actuation system as recited in claim 6 wherein the outer peripheral surface of the piston includes an unfilled or unreinforced plastic material, and the remainder of the piston includes a filled or reinforced plastic material.

8. The hydraulic clutch actuation system as recited in claim 7 wherein the outer peripheral surface of the piston is made of the same base plastic as the piston.

9. The hydraulic clutch actuation system as recited in claim 1 wherein the sliding contact surface or the outer peripheral surface is a material having modified sliding properties.

10. The hydraulic clutch actuation system as recited in claim 1 wherein the weld ring member or the piston is a two-component injection-molded part.

11. The hydraulic clutch as recited in claim 1 wherein the plastic cylinder housing part is a slave cylinder housing part or a master cylinder housing part.

12. The hydraulic clutch as recited in claim 4 wherein the first plastic component and the cylinder housing part are made of polyamide 66.
